(19) United States
(12) Patent Application Publication
(10) Pub. No.: US 2008/0117851 A1
(43) Pub. Date: May 22, 2008

(54) Wireless terminal and wireless terminal control method

(76) Inventors: Masataka Irie, Osaka (JP); Takeshi Hatakeyama, Osaka (JP); Takeshi Yoshida, Osaka (JP)

Correspondence Address: MCDERMOTT WILL & EMERY LLP, 600 13TH STREET, NW, WASHINGTON, DC, 20005-3096, US

(21) Appl. No.: 11/976,675

(22) Filed: Oct. 26, 2007

(30) Foreign Application Priority Data
Nov. 20, 2006 (JP) 2006-313620

(51) Int. Cl. G08C 17/00

(52) U.S. Cl. 370/311

(57) ABSTRACT

Prior to detection of a start of a session having periodicity in a wireless terminal, the wireless terminal powers on a communication unit that performs wireless communication with a wireless base station, in accordance with a reception timing of receiving a beacon signal once in several times and a generation timing of transmission packets of sessions. After the start of a session having periodicity has been detected in the wireless terminal, the communication unit is only powered on when transmission packets of sessions having periodicity are generated.

### BACKGROUND OF INVENTION

1. Field of the Invention

The present invention relates to power-saving technology in a wireless terminal.

2. Description of the Related Art

Two operation modes of wireless terminals related to power management in IEEE 802.11 are an active mode and a power save mode. A wireless terminal in the power save mode regularly transitions between an awake state in which power is completely supplied to a transmission/reception circuit and the like and transmission and reception are possible, and a doze state in which the wireless terminal operates on a minimum necessary quantity of power and transmission and reception are impossible.

Generally, in accordance with Listen Intervals (parameters specifying a cycle for receiving beacon signals) and Receive DTIMs (setting parameters specifying whether to receive every beacon signal that includes a DTIM information element), the wireless terminal transitions from the doze state to the awake state at a cycle for receiving, once in several times, beacon signals transmitted by an access point at a constant cycle.

Also, when a currently running application generates a transmission packet, the wireless terminal transitions from the doze state to the awake state in order to transmit a transmission frame generated based on the transmission packet to the access point.

In this way, common wireless terminals transition from the doze state to the awake state to receive, once in several times, beacon signals transmitted by the access point, and also to transmit the transmission frame generated in accordance with the transmission packet by the current application to the access point, and energy is consumed by the transmission/reception circuit and the like.

To conserve energy in wireless terminals, Japanese Patent Application No. 2004-260386 discloses technology such as the following, which focuses on applications requiring real time capability in audio communications and the like (hereinafter referred to as real time applications).

When a real time application begins operations, the wireless terminal transitions from the doze state to the awake state and transmits a PS-Poll to the access point regardless of the beacon signal only if a transmission packet has been generated by the real time application (Power Save-Poll: used by the wireless terminal to request the access point to transmit a packet addressed to the wireless terminal). This reduces the number of times that the wireless terminal transitions from the doze state to the awake state.

However, in the technology disclosed in the above patent document 1, if the real time application does not generate a transmission packet for a long period of time, the wireless terminal maintains a long-lasting doze state. As a result, there is a decline in communication quality due to a delay in the wireless terminal acquiring the packets addressed to itself that have accumulated in the access point.

In this way, although the technology disclosed in patent document 1 can realize energy conservation in a wireless terminal, there is the possibility of the doze state continuing for a long period of time.

### SUMMARY OF INVENTION

The present invention has been achieved in view of the above problem, and an aim thereof is to provide a wireless terminal and a wireless terminal control method that enable conserving energy while avoiding a long-lasting state in which a communication unit that performs wireless communication with a wireless base station is not powered on.

In order to achieve the above aim, a wireless terminal of the present invention includes a communication unit operable to perform wireless communication with a wireless base station; a control unit operable to activate the communication unit upon receiving a power-on instruction; a power-on instruction unit operable to transmit the power-on instruction to the control unit; and a detection unit operable to detect a start of a repeating session in which transmission data is repeatedly generated, wherein after the start of the repeating session has been detected by the detection unit, the power-on instruction unit transmits the power-on instruction upon an occurrence of an event pertaining to the transmission data in the repeating session.

A control method for a wireless terminal in the present invention includes a communication unit that performs wireless communication with a wireless base station, a control unit that activates the communication unit upon receiving a power-on instruction, and a power-on instruction unit that transmits the power-on instruction to the control unit, the control method including a detection step of detecting a start of a repeating session in which transmission data is repeatedly generated; and a power-on instruction step of transmitting the power-on instruction upon an occurrence of an event pertaining to the transmission data in the repeating session, after the start of the repeating session has been detected in the detection step.

According to the wireless terminal, upon detection of the start of the repeating session, the communication unit is powered on only when there is an occurrence of an event of the transmission data of the repeating session whose start has been detected. Accordingly, after the start of the repeating session has been detected, energy can be conserved and the number of times that the communication unit is powered on can be reduced, compared to a case in which the operable to detect a start of a repeating session in which transmission data is repeatedly generated, wherein after the start of the repeating session has been detected by the detection unit, the power-on instruction unit transmits the power-on instruction upon an occurrence of an event pertaining to the transmission data in the repeating session.

A control method for a wireless terminal in the present invention includes a communication unit that performs wireless communication with a wireless base station, a control unit that activates the communication unit upon receiving a power-on instruction, and a power-on instruction unit that transmits the power-on instruction to the control unit, the control method including a detection step of detecting a start of a repeating session in which transmission data is repeatedly generated; and a power-on instruction step of transmitting the power-on instruction upon an occurrence of an event pertaining to the transmission data in the repeating session, after the start of the repeating session has been detected in the detection step.

According to the wireless terminal, upon detection of the start of the repeating session, the communication unit is powered on only when there is an occurrence of an event of the transmission data of the repeating session whose start has been detected. Accordingly, after the start of the repeating session has been detected, energy can be conserved and the number of times that the communication unit is powered on can be reduced, compared to a case in which the communication unit is powered on when there is an occurrence of an event of the cycle of receiving beacon signals once in several times and when there is an occurrence of an event of the transmission data of a session.

Also, since the communication unit is powered on by the occurrence of the event of the transmission data of the repeating session, a situation in which the communication unit is not powered on for a long period of time can be avoided.

The wireless terminal above may further include an accumulation unit operable to have accumulated therein transmission data of other sessions, wherein after the start of the repeating session has been detected, the communication unit may transmit the transmission data pertaining to the occurrence of the event in the repeating session and the transmission data that has accumulated in the accumulation unit.

This structure enables avoiding a situation in which the wireless terminal does not transmit transmission data generated in sessions other than repeating sessions to the wireless base station, and the transmission data continuously accumulates in the wireless terminal.

In the wireless terminal above, after the start of the repeating session has been detected, the communication unit may (i) transmit the transmission data generated in the repeating session, and (ii) transmit a polling frame for acquiring, from the wireless base station, data addressed to the wireless terminal that has been accumulated in the wireless base station, and receive the addressed data.

This structure enables avoiding a situation in which transmission data addressed to the wireless terminal that has accumulated in the wireless base station is not sent to the wireless terminal, and continuously accumulates in the wireless base station.

In the wireless terminal above, the repeating session may be a cyclic session in which the transmission data is generated at a predetermined cycle, and if a plurality of the cyclic sessions have started, the power-on instruction unit may transmit the power-on instruction upon the occurrence of the event that pertains to, from among the plurality of cyclic sessions, a cyclic session having a shortest cycle.

According to this structure, if a plurality of cyclic sessions have started, using the cyclic session having the shortest cycle to trigger generating a power-on instruction enables reducing the number of times the communication unit is powered on, thus conserving more energy than a case in which a power-on instruction is generated in every cyclic session. Also, this structure enables suppressing delays in transmitting the transmission data generated in sessions other than the cyclic session having the shortest cycle.

In the wireless terminal above, after the start of the repeating session has been detected, the power-on instruction unit may transmit the power-on instruction further upon an occurrence of an other event at a predetermined timing, the predetermined timing being when data transmitted by one of multicast and broadcast following a beacon signal from the wireless base station can be received and when the beacon signal from the wireless base station cannot be received.

This structure enables the wireless device to receive data transmitted by the wireless base station by broadcast or multicast following the beacon signal, and also enables reducing the amount of time that the communication unit is powered on.

In the wireless terminal above, if a plurality of the repeating sessions have started, the power-on instruction unit may transmit the power-on instruction upon the occurrence of the event that pertains to, from among the plurality of repeating sessions, at least one session of one of VoIP, MPEG-TS, and MPEG-PS.

This structure enables avoiding a situation in which the event for powering on the communication unit does not occur.

In wireless terminal above, after the start of the repeating session has been detected, the power-on instruction unit may transmit the power-on instruction further upon an occurrence of an other event of a predetermined control frame to be transmitted to the wireless base station.

This structure enables suppressing the wireless terminal's energy consumption while transmitting the control frames to the wireless base station.

In the wireless terminal above, after the start of the repeating session has been detected, the power-on unit may transmit a power-on instruction further upon an occurrence of an event of a timing at which a stream frame transmitted from the wireless base station can be received.

This structure enables the wireless terminal to minimize the number of times that the communication unit is powered on to receive stream frames transmitted by the wireless base station, and to reliably receive the stream frames.

The wireless terminal above may further include a vicinity search frame detection unit operable to detect a vicinity search frame including an address of an other wireless terminal that has been transmitted via one of broadcast and multicast from the wireless base station; a cycle detection unit operable to, based on a result of the detection performed by the vicinity search frame detection unit, detect a cycle at which the vicinity search frame is transmitted, wherein after the start of the repeating section has been detected, the power-on instruction unit may transmit a power-on instruction further upon the occurrence of an event of the cycle at which the vicinity search frame detected by the vicinity search frame detection unit is transmitted.

This structure enables the wireless terminal to receive vicinity search frames, to obtain the addresses of other wireless terminals, and to minimize the number of times that the communication unit is powered on to receive vicinity search frames transmitted by the wireless base station.

The wireless terminal above may further include a user setting unit operable to receive a setting operation from a user, wherein after the start of the repeating session has been detected, during a period that begins when the user setting unit receives a predetermined first setting operation and ends when the user setting unit receives a second predetermined setting operation, the power-on instruction unit may transmit the power-on instruction upon the occurrence of an event of a cycle of a beacon signal that accompanies a transmission of a frame via one of broadcast and multicast, instead of upon the occurrence of the event of the cycle at which the vicinity search frame detected by the vicinity search frame detection unit is transmitted.

According to this structure, for example if a new wireless terminal is provided, the original wireless terminal can receive all of the data transmitted by broadcast or multicast following the beacon signal in accordance with the predetermined setting operation of the user. This structure enables the original wireless terminal to reliably acquire the address of the new wireless terminal.

The wireless terminal above may further include a user setting unit operable to receive a setting operation from a user, wherein after the start of the repeating session has been detected, during a period that begins when the user setting unit receives a predetermined setting operation and ends when the vicinity search frame detection unit detects a vicinity search frame, the power-on instruction unit may transmit the power-on instruction upon the occurrence of an event of a cycle of a beacon signal that accompanies a transmission of a frame via one of broadcast and multicast, instead of upon the occurrence of the event of the cycle at which the vicinity search frame detected by the vicinity search frame detection unit is transmitted.

According to this structure, for example if a new wireless terminal is provided, the original wireless terminal can receive all of the data transmitted by broadcast or multicast following the beacon signal in accordance with the predetermined setting operation of the user. This structure enables the original wireless terminal to reliably acquire the address of the new wireless terminal.

### BRIEF DESCRIPTION OF DRAWINGS

These and other objects, advantages, and features of the invention will become apparent from the following description thereof taken in conjunction with the accompanying drawings, which illustrate specific embodiments of the present invention.

FIG. 1 shows a system structure of a wireless communication system of embodiment 1;

FIG. 2 shows a system structure of the wireless terminal of FIG. 1;

FIG. 3 is a flowchart showing a flow of operations performed by the wireless terminal of FIG. 2;

FIG. 4 is a flowchart showing an interruptible power-on processing flow of FIG. 3;

FIG. 5 is a flowchart showing a cyclic/continuous session power-on processing flow of FIG. 3;

FIG. 6 shows an exemplary operation sequence performed by the wireless communication system of FIG. 1;

FIG. 7 shows an exemplary operation sequence performed by the wireless communication system of FIG. 1 after detection of a start of a cyclic session;

FIG. 8 is a flowchart showing a cyclic/continuous session power-on processing flow of embodiment 2;

FIG. 9 shows an exemplary operation sequence performed by the wireless communication system of embodiment 2 after detection of a start of a cyclic/continuous session;

FIG. 10 is a flowchart showing a cyclic session power-on processing flow of embodiment 3;

FIG. 11 shows an exemplary operation sequence performed by the wireless communication system of embodiment 3 after detection of the start of the cyclic/continuous session;

FIG. 12 shows a structure of a wireless terminal of embodiment 4; and

FIG. 13 is a flowchart showing a learning processing flow performed by the wireless terminal of FIG. 12 in a transmission cycle for a vicinity search packet.

### DESCRIPTION OF THE PREFERRED EMBODIMENTS

### Embodiment 1

Embodiment 1 of the present invention is described below with reference to the drawings. Note that since the present invention focuses on a power save mode in a wireless terminal, the present embodiment and embodiments hereinafter describe cases in which a mobile terminal is operating in the power save mode.

System Structure of a Wireless Communication System

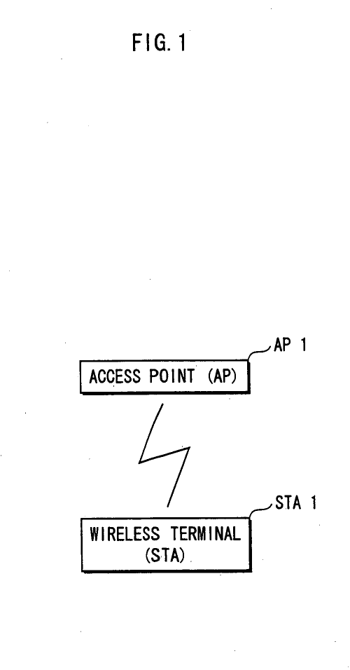

Following is a description of the system structure of a wireless communication system of the present embodiment with reference to FIG. 1. FIG. 1 shows a system structure of the wireless communication system of the present embodiment.

The wireless communication system includes an access point (AP) AP 1 and a wireless terminal (STA) STA 1. Note that a plurality of access points and a plurality of wireless terminals are provided in the wireless communication system, and each wireless terminal is wirelessly connected to an access point.

The access point AP 1 transmits a beacon signal at a constant cycle.

The beacon signal includes a Timestamp information element, a TIM information element (Traffic Indication Map: an information element for notifying the wireless terminal in power save mode that data has accumulated), and the like. In particular, a TIM included in a beacon signal transmitted when a DTIM count of the TIM information element reaches 0 is called a DTIM (Delivery Traffic Indication Message).

Also, a Beacon Interval information element is included in the beacon signal, and a beacon cycle is set in the Beacon Interval information element.

The wireless terminal STA 1 receives, once in several times, beacon signals transmitted by the access point AP 1 in accordance with, for example, Listen Intervals and Receive DTIMs.

In the wireless terminal STA 1 of the present embodiment, before detection of a start of a session for transmitting an uplink frame (hereinafter referred to as a cyclic session) at a constant cycle and a session having continuity in which packets are continuously transmitted (hereinafter referred to as a continuous session), a power-on instruction is sent to a communication control unit (described later) and a MAC unit (described later) is activated upon the occurrence of the event of the cycle at which a beacon signal is received once in several times and upon the occurrence of an event of the transmission data generated in sessions established by the wireless terminal.

Cyclic sessions include sessions established by, for example, SIP, MPEG-TS, and MPEG-PS. Also, “having continuity” refers to a case in which subsequent packets, such as packets for negotiation or streaming delivery, are clearly present.

Note that the cyclic session and the continuous session correspond to the repeating sessions.

In the wireless terminal STA 1 of the present embodiment, after detection of a start of either a cyclic session or a continuous session, a power-on instruction is sent to the communication control unit (described later) and the MAC unit (described later) is activated upon the occurrence of an event of transmission data generated in the cyclic session or the continuous session whose start has been detected.

Structure of the Wireless Terminal

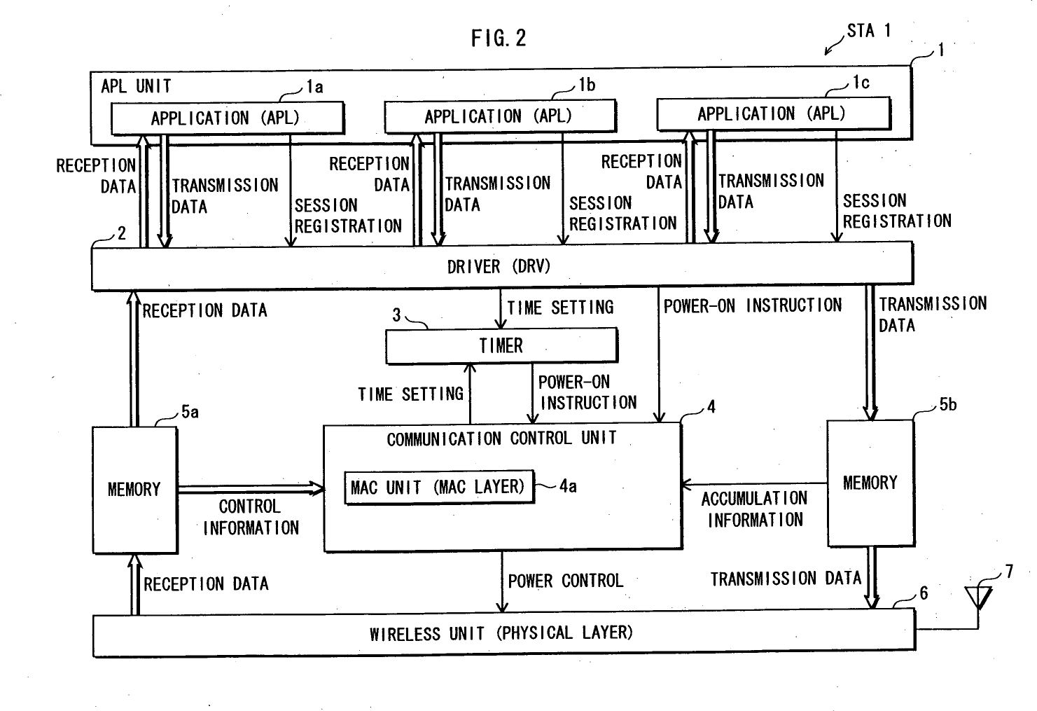

Following is a description of the structure of the wireless terminal of FIG. 1 with reference to FIG. 2. FIG. 2 shows a system structure of the wireless terminal of FIG. 1.

The wireless terminal STA 1 includes an APL unit 1 in which applications 1a, 1b, 1c, etc. operate, a driver 2, a timer 3, a communication control unit 4, memories 5a and 5b, a wireless unit 6, and an antenna 7.

The applications (APLs) 1a, 1b, and 1c register sessions on the driver 2 and perform transmission/reception of transmission data and reception data with the driver 2.

The driver 2 performs transmission/reception of transmission data and reception data with the memories 5a and 5b, the application 1a, etc. Also, the driver 2 detects the start of a cyclic session or a continuous session based on a notification from an application or session information of a session that has been registered. For example, in SIP, the application notifies the driver 2 the session started due to the reception of an “Invite” request, as a result of which the driver 2 detects the start of the continuous session. Also, ptime, etc. in SIP corresponds to session information. Note that if the session information of the cyclic sessions and the continuous sessions are pre-stored in a memory, not depicted, the start of the cyclic session or the continuous session may also be detected by matching the registered session to one of the sessions stored in the memory.

The driver 2 performs various types of processing such as setting a time in the timer 3 at which the timer 3 sends a power-on instruction, and sending a power-on instruction to the communication control unit 4.

In the present embodiment, before a start of a cyclic session or a continuous session is detected, the driver 2 sends a power-on instruction to the communication control unit 4 upon the occurrence of an event of transmission data generated in the sessions. Also, after the start of either the cyclic session or the continuous session has been detected, the driver 2 sends a power-on instruction to the communication control unit 4 upon the occurrence of an event of the transmission data generated in the cyclic session or continuous session whose start has been detected.

The timer 3 has a time set by the driver 2 or the communication control unit 4, and when the timer value reaches the time that was set, the timer 3 sends a power-on instruction to the communication control unit 4. In the present embodiment, the timer 3 only sends the power-on instruction during a cycle other than the cycle that begins when the start of either a cyclic session or a continuous session is detected and ends when the end of the session is detected.

The communication control unit 4 includes a MAC unit 4a that performs communication control at a MAC layer. Upon receiving a power-on instruction from either the driver 2 or the timer 3, the communication control unit 4 powers on the MAC unit 4a. Thus, the MAC unit 4a is activated, and communication control at the MAC layer is performed by the MAC unit 4a.

Also, the MAC unit 4a receives control information from the memory 5a and accumulation information from the memory 5b. The MAC unit 4a performs various processing such as setting the time of the timer 3 at which the beacon signal transmitted from the access point AP 1 can be received once in several times, and performing power control of the wireless unit 6.

The memory 5a receives reception data from the wireless unit 6, and accumulates the received reception data. The memory 5a transfers the accumulated reception data to the driver 2, and also transfers the control information included in the accumulated reception data to the MAC unit 4a of the communication control unit 4.

The memory 5b receives transmission data from the driver 2, and accumulates the received transmission data. The memory 5b transfers accumulation information indicating whether unsent transmission data has accumulated to the MAC unit 4a of the communication control unit 4, and furthermore transfers the accumulated transmission data to the wireless unit 6.

The wireless unit 6 and the antenna 7 perform communication processing at a physical layer. Power control of the wireless unit 6 is performed by the communication control unit 4. The wireless unit 6 transfers the reception data received via the antenna 7 to the memory 5a, and transmits the reception data output from the memory 5b via the antenna 7.

Operation Flow of the Wireless Terminal

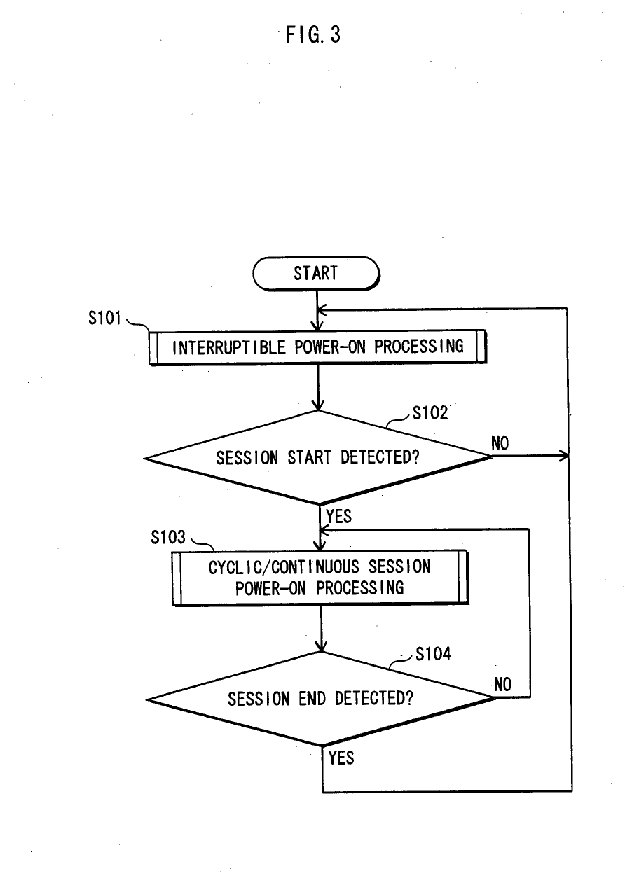

Following is a description of the operations of the wireless terminal of FIG. 2 with reference to FIG. 3. FIG. 3 is a flowchart showing a flow of operations performed by the wireless terminal of FIG. 2.

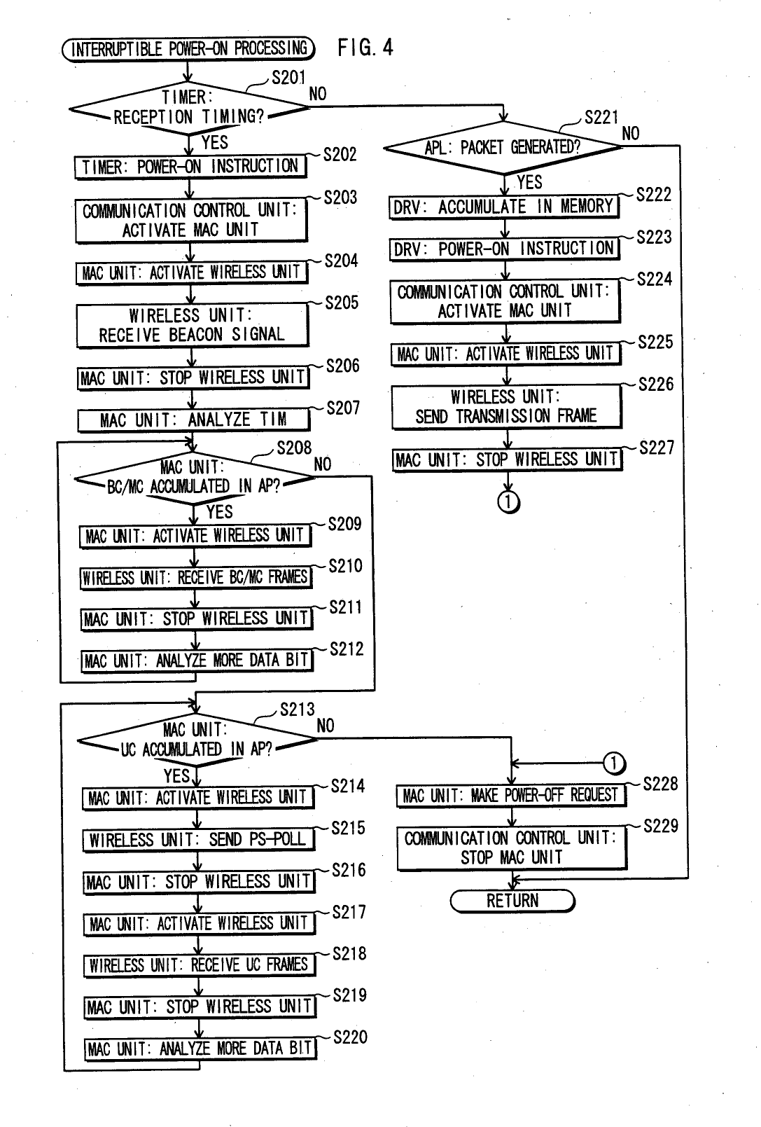

The wireless terminal STA 1 invokes interruptible power-on processing (FIG. 4), and the interruptible power-on processing is performed (step S101).

The driver 2 of the wireless terminal STA 1 detects the start of a cyclic session or continuous session, and determines whether the start of the cyclic session or continuous session was detected (step S102).

If the start of neither session was detected (S102:NO), the processing of step S101 is performed.

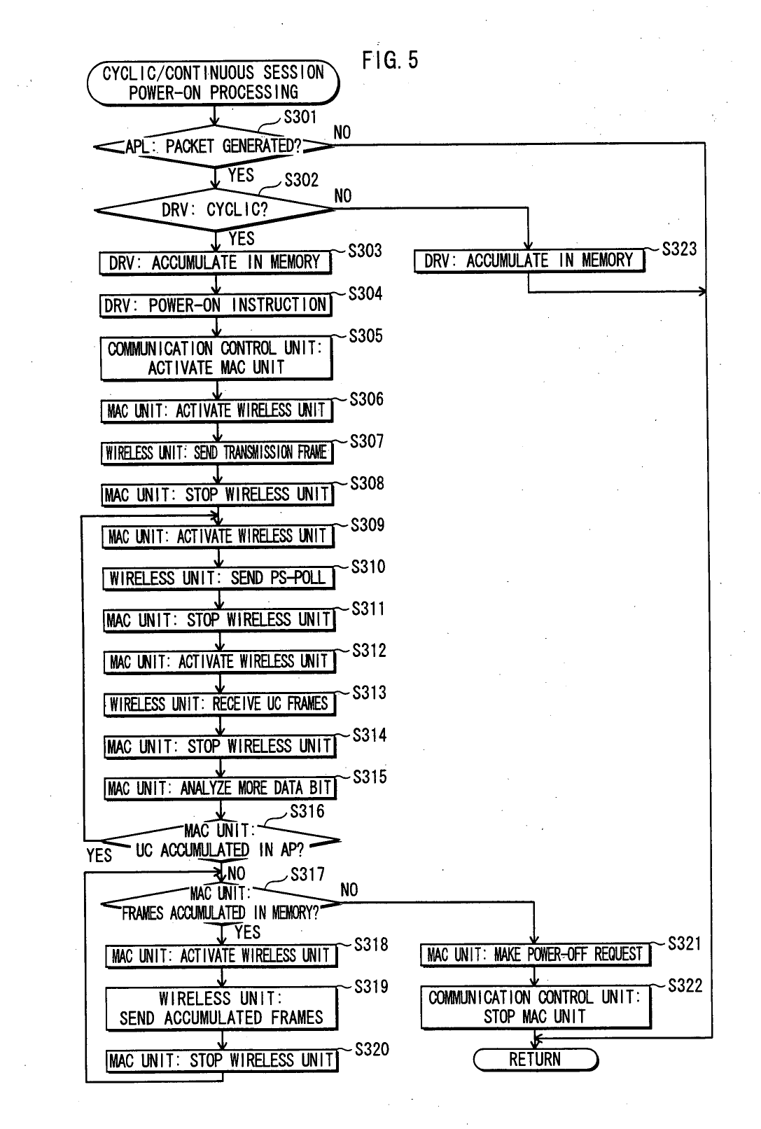

If the start of either session is detected (S102:YES), the wireless terminal STA 1 invokes cyclic/continuous session power-on processing (FIG. 5), and cyclic/continuous session power-on processing is performed (step S103).

The driver 2 of the wireless terminal STA 1 detects an end of the cyclic session or the continuous session whose start has been detected, and judges whether the end of the session has been detected (step S104).

If the end is not detected of the cyclic session or continuous session whose start has been detected (S104:NO), the processing of step S103 is performed, and if the end is detected of the cyclic session or continuous session whose start has been detected (S104:YES), the processing of step S101 is performed.

Interruptible Power-on Processing Flow in the Wireless Terminal

The following describes the interruptible power-on processing flow of FIG. 3 with reference to FIG. 4. FIG. 4 is a flowchart showing the interruptible power-on processing flow of FIG. 3.

In the timer 3, a time at which beacon signals transmitted by the access point AP 1 can be received once in several times is set by the MAC unit 4a of the communication control unit 4.

The timer 3 determines whether the reception timing at which to receive a beacon signal from the access point AP 1 has been reached, that is to say, determines whether the time set by the MAC unit 4a has been reached (step S201). If the reception timing has been reached (S201:YES), the processing of step S202 is performed.

The timer 3 sends a power-on instruction to the communication control unit 4 (step S202), which receives the power-on instruction and powers on the MAC unit 4a to activate the MAC unit 4a (step S203).

The MAC unit 4a activates the wireless unit 6 (step S204). The wireless unit 6 receives beacon signals from the access point AP 1, and the beacon signals are accumulated in the memory 5a (step S205). When a predetermined time period has passed after activating the wireless unit 6, the MAC unit 4a stops the wireless unit 6 (step S206). Note that since “when a predetermined time period has passed after activating the wireless unit 6” is not the main matter of the present invention, description thereof is omitted below.

The memory 5a outputs control information included in the accumulated beacon signals to the MAC unit 4a. The MAC unit 4a analyzes a TIM that is one piece of the control information output from the memory 5a (step S207).

The MAC unit 4a determines whether unsent frames to be transmitted by broadcast or multicast (hereinafter called BC/MC frames) have accumulated in the access point AP 1 (step S208) in accordance with a result of the TIM analysis or a result of a More Data Bit analysis, described later. If unsent BC/MC frames have accumulated in the access point AP 1 (S208:YES), the processing of step S209 is performed.

The MAC unit 4a activates the wireless unit 6 (step S209). The wireless unit 6 receives BC/MC frames from the access point AP 1. The BC/MC frames accumulate in the memory 5a, and furthermore are output to the driver 2 and the corresponding application (step S210). The MAC unit 4a stops the wireless unit 6 (step S211).

The memory 5a outputs the control information included in the accumulated BC/MC frames to the MAC unit 4a. The MAC unit 4a analyzes the More Data Bit that is one piece of the control information output from the memory 5a (step S212), and the processing of S208 is performed.

In the determination step of step S208, if a determination is made that unsent BC/MC frames have not accumulated in the access point AP 1 (S208:NO), the MAC unit 4a determines whether unsent frames addressed to itself to be transmitted by unicast (hereinafter referred to as UC frames) have accumulated in the access point AP 1, based on the result of the TIM analysis or the result of the More Data Bit analysis, described later (step S213). If unsent UC frames have accumulated in the access point AP 1 (S213:YES), the processing of step S214 is performed.

The MAC unit 4a activates the wireless unit 6 (step S214). The wireless unit 6 transmits a PS-Poll to the access point AP 1 (step S215). The MAC unit 4a stops the wireless unit 6 (step S216).

The MAC unit 4a activates the wireless unit 6 (step S217). The wireless unit 6 receives UC frames transmitted from the access point AP1. The UC frames accumulate in the memory 5a, and furthermore are output to the driver 2 and the corresponding application (step S218). The MAC unit 4a stops the wireless unit 6 (step S219).

The memory 5a outputs the control information included in the accumulated UC frames to the MAC unit 4a. The MAC unit 4a analyzes the More Data Bit that is one of the pieces of the control information output from the memory 5a (step S220), and the processing of step S213 is performed.

In the determination step of step S213, if unsent UC frames have not accumulated in the access point AP 1 (S213:NO), the MAC unit 4a makes a power-off request to the communication control unit 4 (step S228), and the communication control unit 4 stops the MAC unit 4a (step S229). Then, processing returns to the original flow of invocation of the interruptible power-on processing.

In the determination step of step S201, if the timing to receive a beacon signal has not been reached (S201:NO), the driver 2 determines whether an application has generated a packet (step S221). If the application has generated a packet (S221:YES), the processing of step S222 is performed, and if the application has not generated a packet (S221:NO), processing returns to the original flow of invocation of the interruptible power-on processing.

The driver 2 stores packets generated by the application in the memory 5b (step S222), and sends a power-on instruction to the communication control unit 4 (step S223) The communication control unit 4 receives the power-on instruction and powers on the MAC unit 4a to activate the MAC unit 4a (step S224).

The MAC unit 4a activates the wireless unit 6 (step S225). The wireless unit 6 transmits transmission frames generated based on the transmission packets accumulated in the memory 5a (step S226). The MAC unit 4a stops the wireless unit 6 (step S227).

The MAC unit 4a makes a power-off request to the communication control unit 4 (step S228), and the communication control unit 4 stops the MAC unit 4a (step S229). Then, processing returns to the original flow of invocation of the interruptible power-on processing.

Cyclic/Continuous Session Power-On Processing Flow in the Wireless Terminal

The following is a description of the cyclic/continuous session power-on processing of FIG. 3 with reference to FIG. 5. FIG. 5 is a flowchart showing the cyclic/continuous session interruptible power-on processing flow of FIG. 3.

The driver 2 determines whether an application has generated a packet (step S301). If the application has generated a packet (S301:YES), the processing of step S302 is performed, and if the application has not generated a packet (S301:NO), processing returns to the original flow of invocation of the cyclic/continuous session power-on processing.

The driver 2 determines whether the generated packet is a packet of an application of either a cyclic session or a continuous session (step S302). If the generated packet is a packet of an application not of a cyclic session or a continuous session (S302:NO), the driver 2 stores the generated packet in the memory 5b (step S323), and processing returns to the original flow of invocation of the cyclic/continuous session power-on processing.

If the generated packet is a packet of an application of either a cyclic session or a continuous session (S302:YES), the driver 2 stores the generated packet in the memory 5b (step S303), and sends a power-on instruction to the communication control unit 4 (step S304). The communication control unit 4 receives the power-on instruction and powers on the MAC unit 4a to activate the MAC unit 4a (step S305).

The MAC unit 4a activates the wireless unit 6 (step S306). The wireless unit 6 transmits transmission frames generated based on the packet generated by an application of either a cyclic session or a continuous session (step S307) The MAC unit 4a stops the wireless unit 6 (step S308).

The MAC unit 4a activates the wireless unit 6 (step S309). The wireless unit 6 transmits a PS-Poll to the access point AP 1 (step S310). The MAC unit 4a stops the wireless unit 6 (step S311).

The MAC unit 4a activates the wireless unit 6 (step S312). The wireless unit 6 receives UC frames transmitted by the access point AP 1, the UC frames are accumulated in the memory 5a, and furthermore are output to the driver 2 and the corresponding application (step S313). The MAC unit 4a stops the wireless unit 6 (step S314).

The memory 5a outputs the control information included in the accumulated UC frames to the MAC unit 4a. The MAC unit 4a analyzes the More Data Bit that is one piece of the control information output from the memory 5a (step S315).

The MAC unit 4a determines whether unsent UC frames addressed to itself have accumulated in the access point AP 1 according to a result of the More Data Bit analysis (step S316). If unsent UC frames have accumulated in the access point AP 1 (S316:YES), the processing of step S309 is performed, and if unsent UC frames have not accumulated in the access point AP 1 (S316:NO), the processing of step S317 is performed.

The MAC unit 4a determines whether any unsent transmission frames generated based on a packet generated by an application not of a cyclic session or a continuous session (hereinafter referred to as accumulation frames) have accumulated in the memory 5b (step S317) based on accumulation information output from the memory 5b. If there are unsent accumulation frames in the memory 5b (step S317:YES), the processing of step S318 is performed.

The MAC unit 4a activates the wireless unit 6 (step S318). The wireless unit 6 transmits the unsent accumulation frames that have accumulated in the memory 5b to the access point AP 1 (step S319). The MAC unit 4a stops the wireless unit 6 (step S320).

In the determination step of step S317, if unsent accumulation frames have not accumulated in the memory 5b (S317:NO), the MAC unit 4a makes a power-off request to the communication control unit 4 (step S321), and the communication control unit 4 stops the MAC unit 4a (step S322) Then, processing returns to the original flow of invocation of cyclic/continuous session power-on processing.

Note that transmitting the PS-Poll before transmitting the accumulation frames enables the wireless terminal STA 1 to acquire downlink packets including packets having periodicity with as little delay as possible at a constant cycle while minimizing time fluctuation due to the influence of packets not having periodicity and changes in the transmission channel.

Operation Sequence of the Wireless Communication System

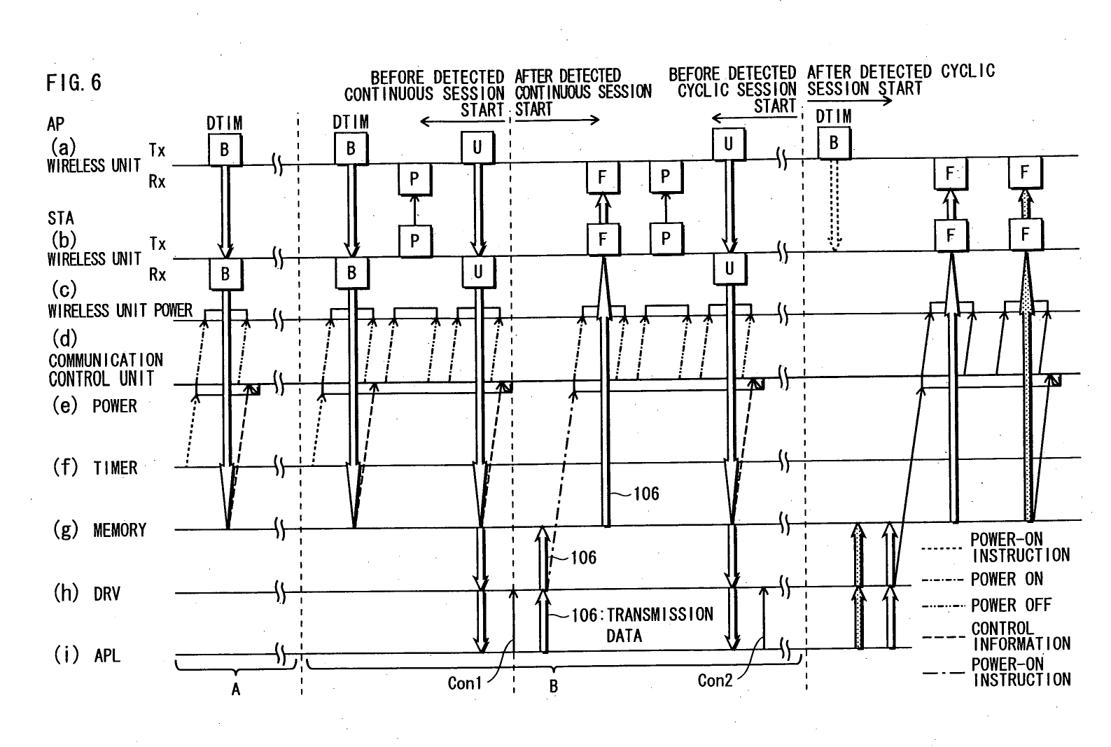

The following is a description of an exemplary operation sequence of the wireless communication system of FIG. 1 with reference to FIG. 6. FIG. 6 shows the exemplary operation sequence performed by the wireless communication system of FIG. 1.

Note, however, that serial power of the wireless unit 6 is on while transmitting and receiving frames of various types, and the serial power is off after the transmission and reception has ended. Note that descriptions of the activation and the stopping of the wireless unit 6 have been omitted for the sake of brevity.

In FIG. 6, and in the operation sequence described below, “B” represents the beacon signals, “P” represents the PS-Polls, “U” represents the UC frames, “M” represents the BC/MC frames, and “F” represents the transmission frames.

Note that a VoIP standby state is a state of waiting for a call after a connection has been made between the access point and the wireless terminal. When the call is generated, negotiation is performed by SIP, H.323, etc. If the VoIP audio data is G.711 or G.729 Annex.A, a cycle of 20 ms is generally used and is transmitted/received between the access point and the wireless terminal, and the cycle of 20 ms is set in the wireless terminal. With use of this setting, the driver of the wireless terminal detects a start of a unicast session that is VoIP in which generation of at least an uplink cyclic frame is guaranteed.

In a section A (in standby), the following processing is performed.

When the set time is reached, the timer 3 sends a power-on instruction to the communication control unit 4. The communication control unit 4 receives the power-on instruction and powers on the MAC unit 4a to activate the MAC unit 4a.

The beacon signal transmitted by the access point AP 1 is received by the wireless unit 6 of the wireless terminal STA 1, and is accumulated in the memory 5a.

The control information included in the beacon signal that has accumulated in the memory 5a is output from the memory 5a to the MAC unit 4a. The MAC unit 4a analyzes the TIM included in the control information, and in the present sequence example, judges that frames have not accumulated in the access point AP 1. Accordingly, the communication control unit 4 stops the MAC unit 4a.

In a section B (in standby), the following processing is performed.

When the set time is reached, the timer 3 sends a power-on instruction to the communication control unit 4. The communication control unit 4 receives the power-on instruction and powers on the MAC 4a to activate the MAC unit 4a.

The beacon signal transmitted by the access point AP 1 is received by the wireless unit 6 of the wireless terminal STA 1, and is accumulated in the memory 5a.

The control information included in the beacon signal accumulated in the memory 5a is output from the memory 5a to the MAC unit 4a. The MAC unit 4a analyzes the TIM included in the control information, and in the present sequence example, judges that UC frames have accumulated in the access point AP 1.

A PS-Poll is transmitted from the wireless unit 6 to the access point AP 1, and UC frames addressed to the wireless terminal STA 1 are transmitted from the wireless unit of the access point AP 1.

The UC frames transmitted by the access point AP 1 are received by the wireless unit 6 of the wireless terminal STA 1, are accumulated in the memory 5a, and furthermore are output to the driver 2 and the corresponding application.

The control information included in the UC frames that have accumulated in the memory 5a is output from the memory 5a to the MAC unit 4a. The MAC unit 4a analyzes the More Data Bit included in the control information, and in the present sequence example, judges that unsent UC frames have not accumulated in the access point AP 1. Accordingly, the communication control unit 4 stops the MAC unit 4a.

In the case of SIP, to notify the start of the continuous session due to accepting an “Invite” request, the application outputs, to the driver 2, information Con 1 including information indicating that the continuous session has started. The driver 2 detects the start of the continuous session by receiving, from the application, the information indicating that the continuous session has started.

The application of the continuous session of which the start has been detected generates a transmission packet (transmission data) 106. The driver 2 stores the transmission packet in the memory 5b and sends a power-on instruction to the communication control unit 4. The communication control unit 4 receives the power-on instruction and powers on the MAC unit 4a to activate the MAC unit 4a.

The transmission frame generated based on the transmission data accumulated in the memory 5b is transmitted from the wireless unit 6 to the access point AP 1, which receives the transmission frame.

A PS-Poll is transmitted from the wireless unit 6 to the access point AP 1, and the UC frames addressed to the wireless terminal STA 1 are transmitted from the wireless unit of the access point AP 1.

The UC frames transmitted by the access point AP 1 are received by the wireless unit 6 of the wireless terminal STA 1, are accumulated in the memory 5a, and are furthermore output to the driver 2 and the corresponding application.

The control information included in the UC frames that have accumulated in the memory 5a is output from the memory 5a to the MAC unit 4a. The MAC unit 4a analyzes the More Data Bit included in the control information, and in the present sequence example, judges that unsent UC frames have not accumulated in the access point AP 1. Accordingly, the communication control unit 4 stops the MAC unit 4a.

When a conversation session has been established, the application registers session information Con 2 in the driver 2. For example, in the case of SIP, ptime and the like are registered. The driver 2 analyzes the content of the session information registered by the application, and detects the start of the cyclic session.

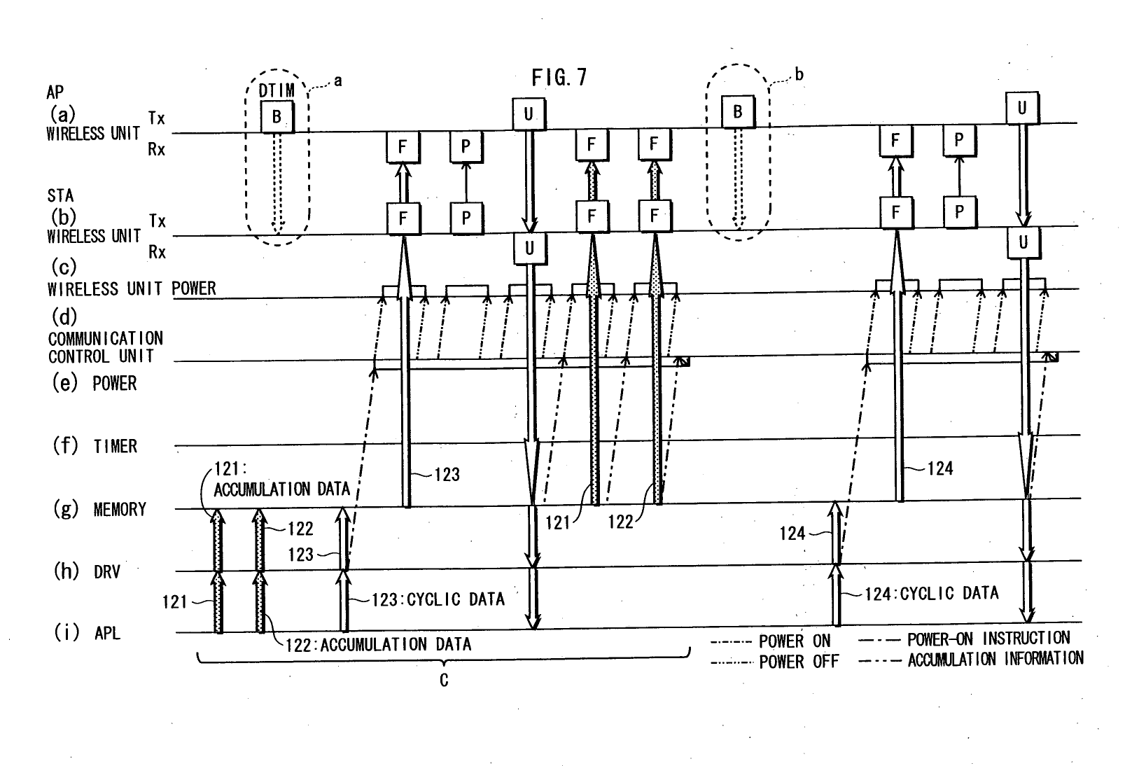

The following describes, with reference to FIG. 7, details of the operation sequence for conversation, etc. performed by the wireless communication system after the start of the cyclic session has been detected.

Operation Sequence of the Wireless Communication System

The following describes the operation sequence performed by the wireless communication system after the start of the cyclic session has been detected with reference to FIG. 7. FIG. 7 shows an exemplary operation sequence performed by the wireless communication system of FIG. 1 after the start of the cyclic session has been detected.

In the wireless terminal STA 1, the power-on instruction is only sent to the communication control unit 4 upon the occurrence of an event of a packet of the cyclic session whose start has been detected. For this reason, as shown in blocks a and b of FIG. 7, beacon signal reception is not performed in the wireless terminal STA 1.

In a section C, the following processing is performed.

In the present exemplary operation sequence, packets generated by an application that does not pertain to the cyclic session whose start has been detected are called, for example, accumulation packets, and packets generated by applications of the cyclic session whose start has been detected are called cyclic packets.

Accumulation packets are generated by applications that do not pertain to the cyclic session whose start has been detected. Accumulation packets (accumulation data) 121 and 122 are output from the application to the driver 2, and are accumulated in the memory 5b by the driver 2. Here, the driver 2 does not send a power-on instruction to the communication control unit 4.

Cyclic packets are generated by applications that pertain to the cyclic session whose start has been detected. A cyclic packet (cyclic data) 123 is output from the application to the driver 2, and is accumulated in the memory 5b by the driver 2. The driver 2 sends a power-on instruction to the communication control unit 4, and the communication control unit 4 receives the power-on instruction and powers on the MAC unit 4a to activate the MAC unit 4a.

Cyclic frames generated based on the cyclic data that has accumulated in the memory 5b are transmitted from the wireless unit 6 to the access point AP 1, which receives the cyclic frames.

A PS-Poll is transmitted from the wireless unit 6 to the access point AP 1, and the UC frames addressed to the wireless terminal STA 1 are transmitted from the wireless unit of the access point AP 1.

The UC frames transmitted by the access point AP 1 are received by the wireless unit 6 of the wireless terminal STA 1, are accumulated in the memory 5a, and are furthermore output to the driver 2 and the corresponding application.

The control information included in the UC frames that have accumulated in the memory 5a is output from the memory 5a to the MAC unit 4a (not depicted in FIG. 7). The MAC unit 4a analyzes the More Data Bit included in the control information, and in the present sequence example, judges that unsent UC frames have not accumulated in the access point AP1.

The MAC unit 4a judges whether there is unsent accumulation data in the memory 5b based on the accumulation information output from the memory 5b. According to a judgment that there is unsent accumulation data in the memory 5b, accumulation frames generated in accordance with the accumulation data 121 and 122 that has accumulated in the memory 5b are sequentially transmitted from the wireless unit 6 to the access point AP 1, which receives the accumulation frames.

The MAC unit 4a judges that there are not unsent accumulation frames in the memory 5b based on the accumulation information output from the memory 5b, and the communication control unit 4 stops the MAC unit 4a.

Thereafter, a cyclic data 124 is generated, and processing such as powering on the MAC unit 4a is performed.

Supplementary Remarks

(1) The above embodiment may be realized such that if the driver 2 detects a plurality of starts of cyclic sessions, the cyclic session having the shortest cycle is specified, and the driver 2 sends a power-on instruction to the communication control unit 4 and the communication control unit 4 activates the MAC unit 4a only if an application of the specified cyclic session having the shortest cycle generates a transmission packet.

In this case, transmission packets generated by applications of sessions other than cyclic sessions, and transmission packets generated by applications of cyclic sessions other than the cyclic session having the shortest cycle accumulate in the memory 5b. When the MAC unit 4a is activated due to the generation of a transmission packet by the application of the cyclic session having the shortest cycle, the wireless unit 6 transmits transmission frames generated based on the transmission packet generated by the application of the cyclic session having the shortest cycle. The wireless unit 6 next transmits, to the access point AP 1, accumulation frames generated based on transmission packets generated by applications of sessions other than cyclic sessions, and accumulation frames generated based on transmission packets generated by applications of cyclic sessions other than the cyclic session having the shortest cycle, which have accumulated in the memory 5b.

(2) The above embodiment may be realized such that if the driver 2 detects a plurality of starts of cyclic sessions, at least one session of VoIP, MPEG-TS, or MPEG-PS is selected, the driver 2 sends a power-on instruction to the communication control unit 4 and the communication control unit 4 activates the MAC unit 4a only if the application of the selected session generates a transmission packet.

In MPEG-TS, 192-byte fixed frames are transmitted at a CBR (Constant Bit Rate) at a constant cycle, and in MPEG-PS variable-length frames are transmitted at a VBR (Variable Bit Rate) at a constant cycle.

In this case, transmission packets generated by applications of sessions other than the selected session (including sessions other than cyclic sessions) are accumulated in the memory 5b. When the MAC unit 4a is activated by generation of a transmission packet by the application of the selected session, the wireless unit 6 transmits transmission frames generated based on transmission packets generated by the application of the selected session. The wireless unit 6 next transmits the accumulation frames generated based on the transmission packets generated by applications of sessions other than the selected session that have accumulated in the memory 5b.

Note that the power-on instruction may be sent to the communication control unit 4 by a hardware terminal that inputs MPEG-TS and MPEG-PS provided in the wireless terminal instead of by the driver 2.

Also, if a plurality of starts of cyclic sessions or continuous sessions are detected, a session of FTP (File Transfer Protocol) or a session of HTTP (Hyper Text Terminal Protocol) may be set as a session for the driver 2 to send the power-on instruction to the communication control unit 4.

(3) In the above embodiment and the below embodiments, the driver 2 sends a power-on instruction to the communication control unit 4 upon generation of a transmission packet by the application of the cyclic session after detection of a start of a cyclic session. However, the driver 2 may set the cycle of the cyclic session in the timer 3, whereupon the timer 3 sends the power-on instruction to the communication control unit 4 according to the set cycle.

(4) The embodiments above and below may be realized such that powering on in accordance with the power-on instruction is performed with respect to all or an arbitrary part of the MAC layers and the physical layers.

The power-on includes applying electric current, and also includes various controls for energy conservation, such as PL control and clock control by gate lock, dynamic clock frequency control, and the like.

### Embodiment 2

The following describes embodiment 2 of the present invention with reference to the drawings.

In embodiment 1, after the start of either the cyclic session or the continuous session has been detected, the power-on instruction is sent to the communication control unit 4 only if a transmission packet is generated in the cyclic session or the continuous session whose start has been detected. However, in the present embodiment, in addition to the case of generation of the transmission packet in the cyclic session or the continuous session whose start has been detected, a power-on instruction is also sent at a timing at which frames transmitted by broadcast or multicast can be received following a beacon signal including a DTIM information element.

For this reason, before detection of the start of a cyclic session or a continuous session, the MAC unit 4a sets, in the timer 3, a time at which beacon signals can be received once in several times. After the detection, the MAC unit 4a sets, in the timer 3, a time at which frames transmitted by broadcast or multicast following the beacon signal including the DTIM information element can be received and the beacon signal is not to be received.

Note that the MAC unit 4a calculates a time to receive the beacon signal including the DTIM information element by analyzing the content, etc., of the information elements of the beacon signal. The MAC unit 4a adds together the time to receive the beacon signals and a shorter time than the time at which the frames are transmitted by broadcast or the like after the transmission of the beacon signal including the DTIM information element. In this way, the MAC unit 4a obtains the time at which frames transmitted by broadcast or multicast following the beacon signal can be received and the beacon signal including the DTIM information element is not to be received.

Note that since the processing that is performed before detecting a start of either a cyclic session or a continuous session is substantially the same in embodiment 1 and embodiment 2, the following description is limited to the processing that is performed after the start of the cyclic session or the continuous session has been detected.

Operations Flow in the Wireless Terminal

Power-On Processing Flow of a Cyclic/Continuous Session in the Wireless Terminal

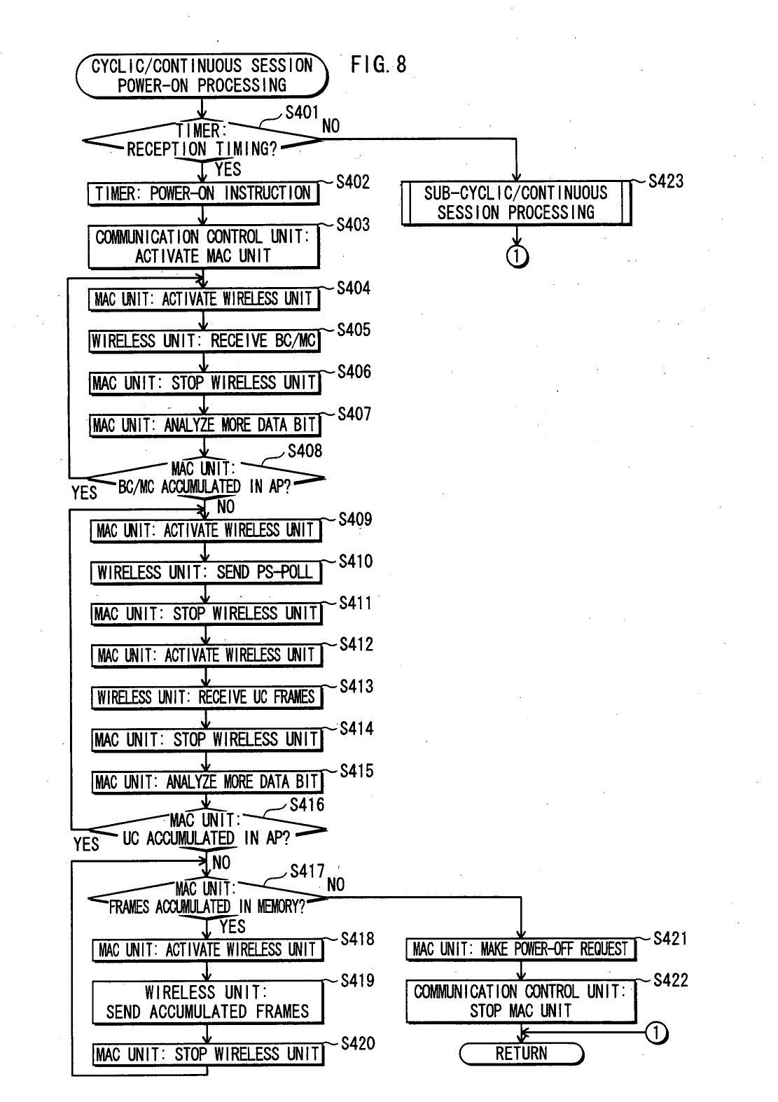

The following is a description of the power-on processing flow of the cyclic/continuous session of the present embodiment with reference to FIG. 8. FIG. 8 is a flowchart showing the cyclic/continuous session power-on processing flow.

The time setting at which frames transmitted by broadcast or multicast following the beacon signal including the DTIM information element can be received and the beacon signal is not to be received has been set in the timer 3 by the MAC unit 4a of the communication control unit 4.

The timer 3 determines whether the reception timing of receiving BC/MC frames transmitted by the access point AP 1 following the beacon signal has been reached, or in other words, if the time set by the MAC unit 4a has been reached (step S401). If the reception timing has been reached (S401:YES), the processing of step S402 is performed, and if the reception timing has not been reached (S401:NO), the wireless terminal STA 1 executes sub-cyclic/continuous session processing (step S423). The sub-cyclic/continuous session processing is the series of processing described in steps S301 to S322 of FIG. 5.

The timer 3 sends a power-on instruction to the communication control unit 4 (step S402), which receives the power-on instruction and powers on the MAC unit 4a to activate the MAC unit 4a (step S403).

The MAC unit 4a activates the wireless unit 6 (step S404). The wireless unit 6 receives the BC/MC frames from the access point AP 1, the BC/MC frames are accumulated in the memory 5a, and are output to the driver 2 and the corresponding application (step S405). The MAC unit 4a stops the wireless unit 6 (step S406).

The memory 5a outputs the control information included in the accumulated BC/MC frames to the MAC unit 4a. The MAC unit 4a analyzes the More Data Bit that is one piece of the control information output from the memory 5a (step S407).

The MAC unit 4a, in accordance with a result of the More Data Bit analysis, determines whether unsent BC/MC frames have accumulated in the access point AP 1 (step S408). If unsent BC/MC frames have accumulated in the access point AP 1 (S408:YES), the processing of step S404 is performed, and if unsent BC/MC frames have not accumulated in the access point AP 1 (S408:NO), the processing of step S409 is performed.

The MAC unit 4a activates the wireless unit 6 (step S409). The wireless unit 6 transmits a PS-Poll to the access point AP 1 (step S410). The MAC unit 4a stops the wireless unit 6 (step S411).

The MAC unit 4a activates the wireless unit 6 (step S412). The wireless unit 6 receives the UC frames from the access point AP 1, and the UC frames are accumulated in the memory 5a and are output to the driver 2 and the corresponding application (step S413) The MAC unit 4a stops the wireless unit 6 (step S414).

The memory 5a outputs the control information included in the accumulated UC frames to the MAC unit 4a. The MAC unit 4a analyzes the More Data Bit that is a piece of the control information output from the memory 5a (step S415).

The MAC unit 4a, in accordance with a result of the More Data Bit analysis, determines whether unsent UC frames have accumulated in the access point AP 1 (step S416). If unsent UC frames have accumulated in the access point AP 1 (S416:YES), the processing of step S409 is performed, and if unsent UC frames have not accumulated in the access point AP 1 (S416:NO), the processing of step S417 is performed.

The memory 5b outputs the accumulation information to the MAC unit 4a. The MAC unit 4a determines, based on the content of the accumulation information output from the memory 5b, whether unsent accumulation data generated in a session other than the cyclic session or continuous session in which a start was detected has accumulated in the memory 5b (step S417). If unsent accumulation data has accumulated in the memory 5b (S417:YES), the processing of step S418 is performed.

The MAC unit 4a activates the wireless unit 6 (step S418). The wireless unit 6 transmits the accumulation frames generated based on the unsent accumulation data to the access point AP 1 (step S419). The MAC unit 4a stops the wireless unit 6 (step S420), and the processing of step S417 is performed.

In the determination step of step S417, if unsent accumulation data has not accumulated in the memory 5b (S417:NO), the MAC unit 4a makes a power-off request to the communication control unit 4 (step S421), and the communication control unit 4 stops the MAC unit 4a (step S422) Processing then returns to the original flow of invocation of the cyclic/continuous session power-on processing.

Operation Sequence in the Wireless Communication System

Operation Sequence in the Wireless Communication System after the Start of a Cyclic/Continuous Session

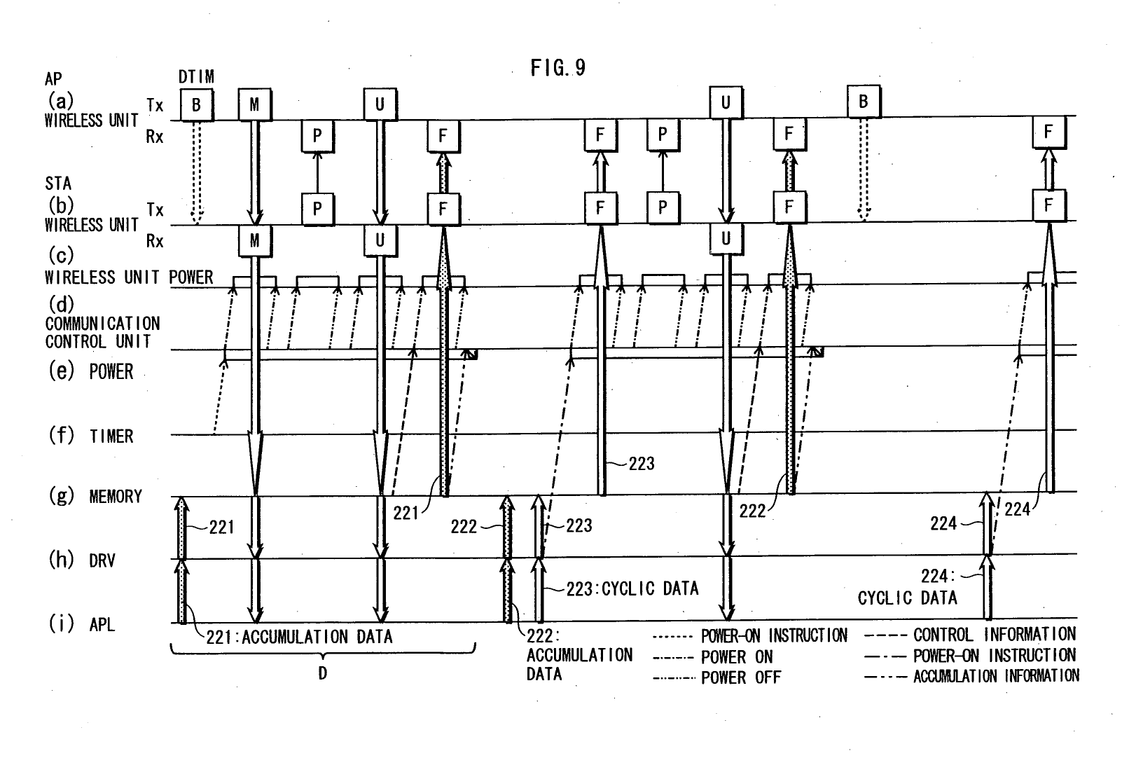

The following describes, with reference to FIG. 9, the operation sequence performed by the wireless communication system of the present embodiment after the start of the cyclic/continuous session has been detected. FIG. 9 shows an exemplary operation sequence performed by the wireless terminal system of embodiment 2 after the start of the cyclic/continuous session has been detected.

The following describes processing in a section D.

In the present exemplary operation sequence, packets generated by an application that does not pertain to the cyclic session whose start has been detected are called accumulation packets or the like.

The accumulation packets are generated by an application that does not pertain to the cyclic session whose start has been detected. The accumulation packet (accumulation data) 221 is output from the application to the driver 2, and is accumulated in the memory 5b by the driver 2. Here, the driver 2 does not send a power-on instruction to the communication control unit 4.

Since the MAC unit 4a and the wireless unit 6 are not powered on at the timing of receiving the beacon signal including the DTIM information element, the wireless terminal STA 1 does not receive the beacon signal including the DTIM information element.

Upon reaching the set time, the timer 3 sends a power-on instruction to the communication control unit 4. The communication control unit 4 receives the power-on instruction and powers on the MAC unit 4a to activate the MAC unit 4a.

The BC/MC frames transmitted following the beacon signal including the DTIM information element by the access point AP 1 are received by the wireless unit 6 of the wireless terminal STA 1, are accumulated in the memory 5a, and furthermore are output to the driver 2 and the corresponding application.

The control information included in the BC/MC frames accumulated in the memory 5a is output from the memory 5a to the MAC unit 4a (not depicted in FIG. 9). The MAC unit 4a analyzes the More Data Bit included in the control information, and in the present exemplary sequence, judges that unsent BC/MC frames have not accumulated in the access point AP 1.

A PS-Poll is transmitted from the wireless unit 6 to the access point AP 1, and the UC frames addressed to the wireless terminal STA 1 are transmitted from the wireless unit of the access point AP1.

The UC frames transmitted by the access point AP 1 are received by the wireless unit 6 of the wireless terminal STA 1, are accumulated in the memory 5a, and furthermore are output to the driver 2 and the corresponding application.

The control information included in the UC frames accumulated in the memory 5a is output from the memory 5a to the MAC unit 4a (not depicted in FIG. 9). The MAC unit 4a analyzes the More Data Bit included in the control information, and in the present exemplary sequence, judges that unsent UC frames have not accumulated in the memory 5a.

The MAC unit 4a judges whether there is unsent accumulation data in the memory 5b based on the accumulation information output from the memory 5b. If there is judged to be unsent accumulation data in the memory 5b, the accumulation frames generated based on the accumulation data 221 accumulated in the memory 5b are transmitted from the wireless unit 6 to the access point AP 1, which receives the accumulation frames. The MAC unit 4a judges that there are not unsent accumulation frames in the memory 5b based on the accumulation information output from the memory 5b, and the communication control unit 4 stops the MAC unit 4a.

Note that since the operation sequence performed when transmission packets are generated by an application of the cyclic session whose start has been detected is substantially the same as embodiment 1, description thereof is omitted. For example, if cyclic data 223 is generated after accumulation data 222 is generated, or if cyclic data 224 is generated when accumulation data has not accumulated in the memory 5b, the MAC unit 4a performs power-on processing, etc. due to the generation of the cyclic data 223 or 224.

In the present embodiment, frames transmitted by broadcast or multicast that include vicinity search frames such as ARP (Address Resolution Protocol) and ND (Neighbor Discovery) can be received.

Supplementary Remark

(1) In the above embodiment, after the detection of the start of the cyclic session, etc., the time set in the timer 3 is the time at which frames transmitted by broadcast or multicast following the beacon signal including the DTIM information element can be received and the beacon signal is not to be received. Alternatively, the above embodiment may be realized such that a stream frame delivery cycle is acquired, and the time set in the timer 3 is a delivery cycle at which frames delivered in a stream following the beacon signal can be received, or a delivery cycle at which frames delivered in a stream following the beacon signal can be received and the beacon signal is not to be received.

### Embodiment 3

The following describes embodiment 3 of the present invention with reference to the drawings.

In embodiment 1, after the start of either a cyclic session or a continuous session has been detected, a power-on instruction is sent to the communication control unit 4 only if a transmission packet is generated in either the cyclic session or the continuous session whose start has been detected. However, in the present embodiment, in addition to sending the power-on instruction if the transmission packet is generated in either the cyclic session or the continuous session whose start has been detected, a power-on instruction is sent if a predetermined control frame is generated.

Note that since processing before the start of either a cyclic session or a continuous session is detected is substantially the same in embodiment 3 as in embodiment 1, the following description is limited to processing after the start of either a cyclic session or a continuous session has been detected.

Operations Flow in the Wireless Terminal

Cyclic/Continuous Session Power-On Processing Flow in the Wireless Terminal

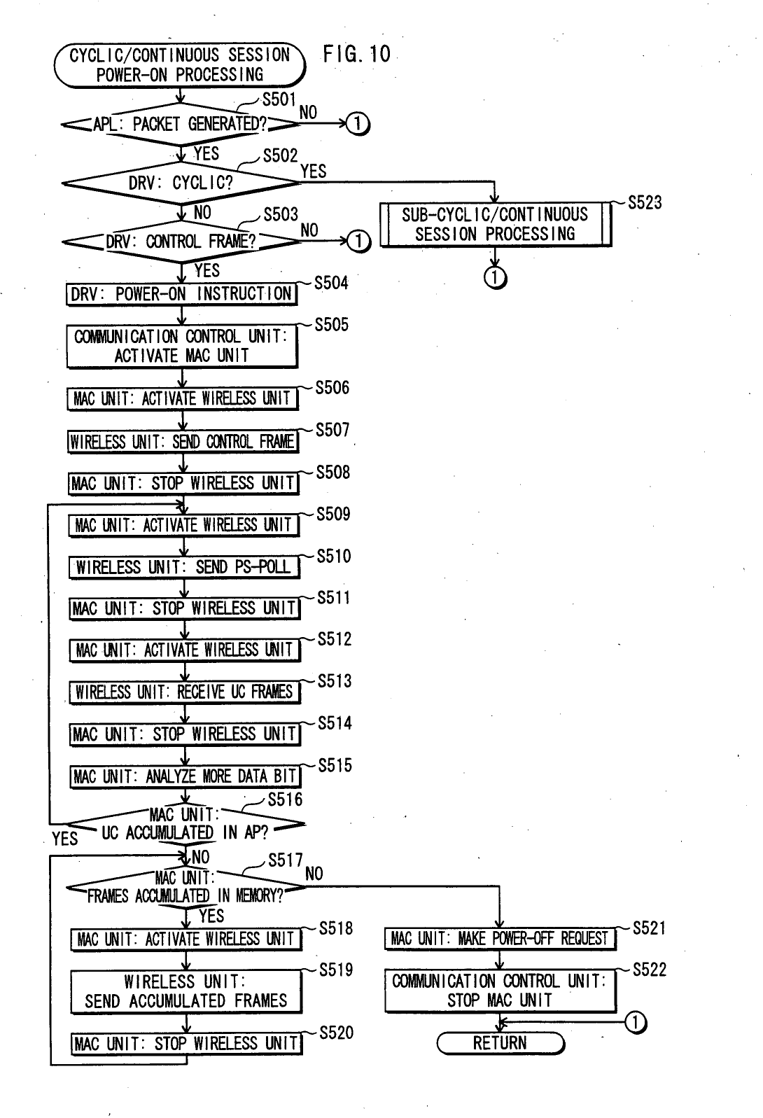

The following describes cyclic/continuous power-on processing in embodiment 3 with reference to FIG. 10. FIG. 10 is a flowchart showing a cyclic session power-on processing flow of the present embodiment.

The driver 2 determines whether the application has generated a packet (step S501). If the application has generated a packet (S501:YES), the processing of step S502 is performed, and if the application has not generated a packet (S501:NO), processing returns to the original flow of invocation of the cyclic/continuous session power-on processing.

The driver 2 determines whether the generated packet is a packet of an application of either a cyclic session or a continuous session (step S502). If the generated packet is a packet of an application of a cyclic session or a continuous session (S502:YES), the wireless unit STA 1 performs sub-cyclic/continuous session processing (step S523). Sub-cyclic/continuous session processing is the series of processing described in steps S303 to S322 of FIG. 5.

If the generated packet is not a packet of an application of either a cyclic session or a continuous session (S502:NO), the processing of step S503 is performed.

The driver 2 determines whether the generated packet pertains to a predetermined control frame (step S503). If the generated packet does not pertain to the predetermined control frame (S503:NO), the driver 2 accumulates the generated packet in the memory 5b, and processing returns to the original flow of invocation of the cyclic/continuous session power-on processing.

Here, the predetermined control frame may be for example, an “Association request”, a “Reassociation request”, a “Probe Request”, a “Disassociation request”, an “Authentication”, or a “Deauthentication” which are a portion of the control frames defined in IEEE802.11. Note that the predetermined control frames are not limited to these.

If the generated packet pertains to the predetermined control frame (S503:YES), the driver 2 generates a control frame based on the generated packet, accumulates the generated control frame in the memory 5b, and the processing of step S504 is performed.

The driver 2 sends a power-on instruction to the communication control unit 4 (step S504). The communication control unit 4 receives the power-on instruction and powers on the MAC unit 4a to activate the MAC unit 4a (step S505).

The MAC unit 4a activates the wireless unit 6 (step S506). The wireless unit 6 transmits the control frames that have accumulated in the memory 5b (step S507). The MAC unit 4a stops the wireless unit 6 (step S508).

The MAC unit 4a activates the wireless unit 6 (step S509). The wireless unit 6 transmits a PS-Poll to the access point AP 1 (step S510). The MAC unit 4a stops the wireless unit 6 (step S511).

The MAC unit 4a activates the wireless unit 6 (step 512). The wireless unit 6 receives the UC frames transmitted from the access point AP 1, the UC frames are accumulated in the memory 5a, and are output to the driver 2 and furthermore to the corresponding application (step S513). The MAC unit 4a stops the wireless unit 6 (step S514).

The memory 5a outputs the control information included in the accumulated UC frames to the MAC unit 4a. The MAC unit 4a analyzes the More Data Bit that is a piece of the control information output from the memory 5a (step S515).

The MAC unit 4a determines whether unsent UC frames addressed to the wireless terminal have accumulated in the access point AP 1 based on a result of the More Data Bit analysis (step S516). If the unsent UC frames have accumulated in the access point AP 1 (S516:YES), the processing of step S509 is performed, and if unsent UC frames have not accumulated in the access point AP 1 (S516:NO), the processing of step 517 is performed.

The MAC unit 4a determines whether unsent transmission frames (accumulation frames) generated by an application that does not pertain to a cyclic session or a continuous session have accumulated in the memory 5b based on the accumulation information output from the memory 5b (step S517). If there are unsent accumulation frames (S517:YES), the processing of step S518 is performed.

The MAC unit 4a activates the wireless unit 6 (step S518). The wireless unit 6 transmits the unsent accumulation frames that have accumulated in the memory 5b to the access point AP 1 (step S519). The MAC unit 4a stops the wireless unit 6 (step S520).

In the determination step of step S517, if there are no unsent accumulation frames in the memory 5b (S517:NO), the MAC unit 4a makes a power-off request to the communication control unit 4 (step S521), and the communication control unit 4 stops the MAC unit 4a (step S522). Then, processing returns to the original flow of invocation of the cyclic/continuous session power-on processing.

Operation Sequence in the Wireless Communication System

Operation Sequence in the Wireless Communication System after the Start of the Cyclic/Continuous Session

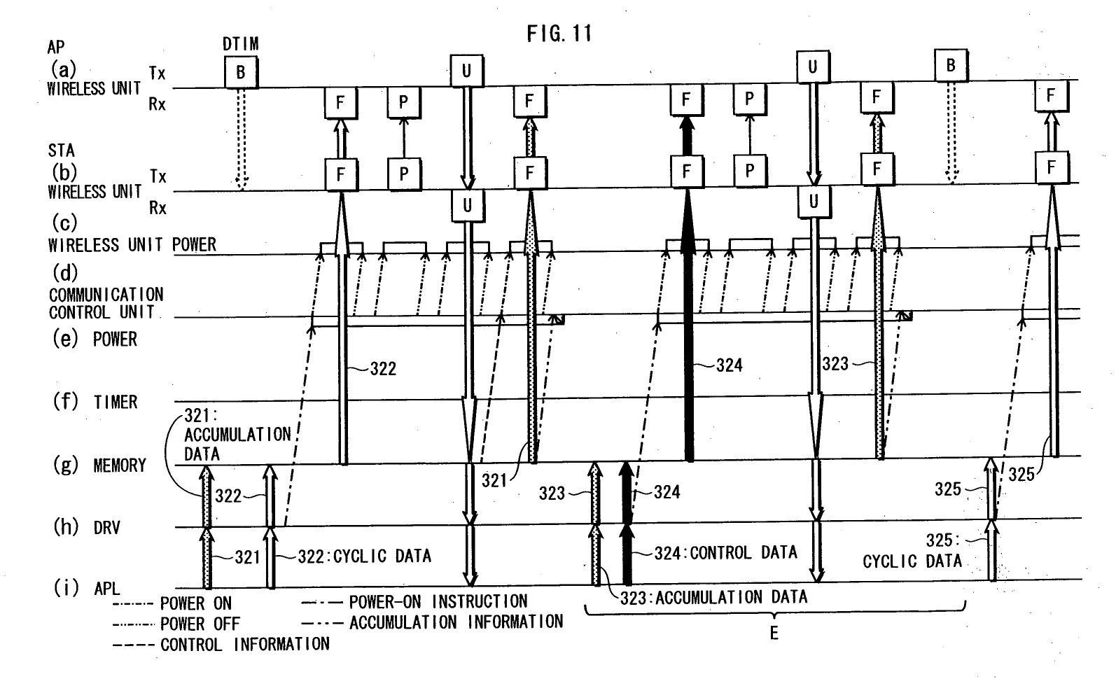

The following is a description of an operation sequence performed by the wireless communication system after the start of the cyclic/continuous session has been detected with reference to FIG. 11. FIG. 11 shows an exemplary operation sequence performed by the wireless communication system of embodiment 3 after the start of the cyclic/continuous session has been detected.

The following describes processing in a section E.

In the present exemplary operation sequence, packets generated by an application that does not pertain to the cyclic session whose start has been detected are called accumulation packets, etc., and packets that pertain to control frames generated by the application are called control packets.

Accumulation packets are generated by applications that do not pertain to the cyclic session whose start has been detected. An accumulation packet (accumulation data) 323 is output from the application to the driver 2, and is accumulated in the memory 5b by the driver 2. Here, the driver 2 does not send a power-on instruction to the communication control unit 4.

A control packet (control data) 324 that pertains to the control frame is generated by the application, and input to the driver 2. The driver 2 generates control frames based on the control data, and accumulates the control frames in the memory 5b. Also, the driver 2 sends a power-on instruction to the communication control unit 4. The communication control unit 4 receives the power-on instruction and powers on the MAC unit 4a to activate the MAC unit 4a.

The wireless unit 6 transmits the control frames to the access point AP 1.

The PS-Poll is transmitted from the wireless unit 6 to the access point AP 1, and UC frames addressed to the wireless terminal STA 1 are transmitted from the wireless unit of the access point AP 1.

The UC frames transmitted by the access point AP 1 are received by the wireless unit 6 of the wireless terminal STA 1, are accumulated in the memory 5a, and furthermore are output to the driver 2 and the corresponding application.

The control information included in the UC frames accumulated in the memory 5a is output from the memory 5a to the MAC unit 4a (not depicted in FIG. 11). The MAC unit 4a analyzes the More Data Bit included in the control information, and in the present exemplary sequence, judges that unsent UC frames have not accumulated in the access point AP 1.

The MAC unit 4a judges whether there is unsent accumulation data in the memory 5b, based on the accumulation information output from the memory 5b. According to a judgment that there is unsent accumulation data in the memory 5b, the accumulation frames generated based on the accumulation data 323 accumulated in the memory 5b is transmitted from the wireless unit 6 to the access point AP 1, which receives the accumulation frames.

The MAC unit 4a judges that there are no unsent accumulation frames in the memory 5b based on the accumulation information output from the memory 5b, and the communication control unit 4 stops the MAC unit 4a.

Note that since the operation sequence performed when transmission packets are generated by an application of the cyclic session whose start has been detected is substantially the same as embodiment 1, description thereof is omitted. For example, if cyclic data 322 is generated after accumulation data 321 is generated, or if cyclic data 325 is generated when accumulation data has not accumulated in the memory 5b, the MAC unit 4a performs power-on processing, etc. due to the generation of the cyclic data 321 or 325.

### Embodiment 4

The following describes embodiment 4 of the present invention with reference to the drawings.

Embodiment 4 is the structure of embodiment 1 with an additional function whereby an application learns a transmission cycle of a vicinity search packet (including an address of a wireless terminal) transmitted by broadcast or multicast following a beacon signal including a DTIM information element. Also, in embodiment 4, after the start of either a cyclic session or a continuous session has been detected, a power-on instruction is sent to the communication control unit 4′ due to the generation of a transmission packet of either the cyclic session or the continuous session whose start has been detected, and the power-on instruction is sent to the communication control unit 4′ at the learned cycle.

### Structure of the Wireless Terminal

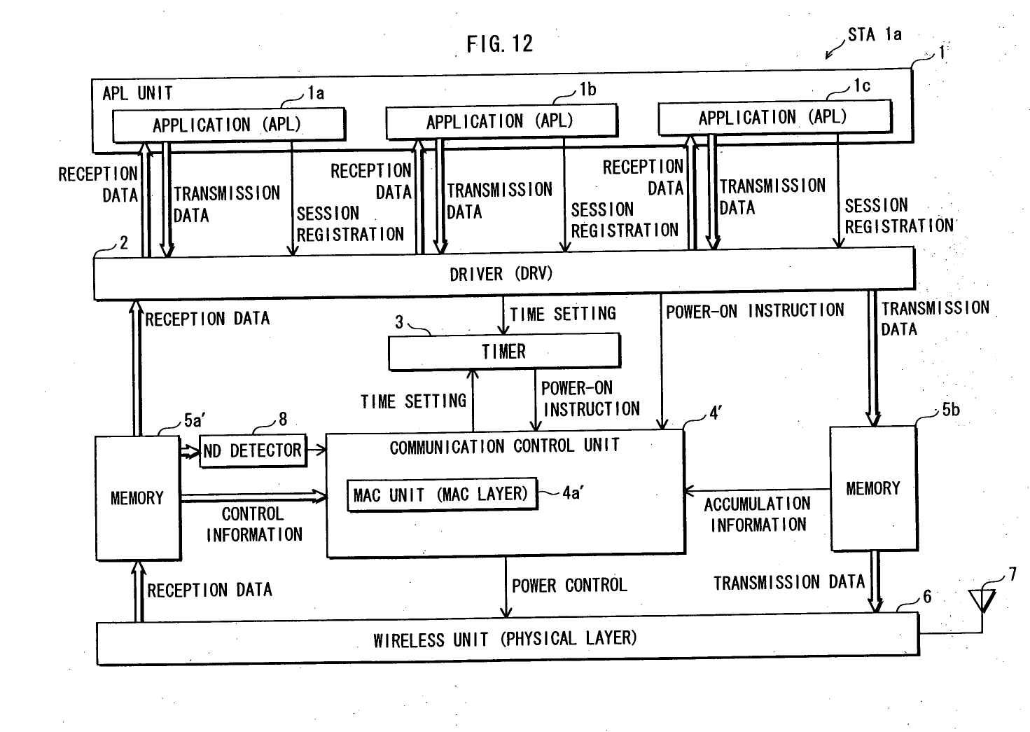

The following describes the structure of the wireless terminal of the present embodiment with reference to FIG. 12. FIG. 12 shows a structure of the wireless terminal of embodiment 4. Note that in the present embodiment, constituent elements having substantially the same functions as embodiment 1 have been given the same reference notations, and description thereof is omitted in the present embodiment since the description of embodiment 1 is applicable.

A memory 5a′ performs the processing of the memory 5a, and additionally outputs, to an ND detector 8, frames transmitted by the access point AP 1 by broadcast or multicast.

The ND detector 8 detects a vicinity search packet.

The MAC unit 4a′ of the communication control unit 4′ performs the processing of the MAC unit 4a, and additionally learns the transmission cycle of the vicinity search packet based on a result of the vicinity search packet detection performed by the ND detector 8 before the start of either the cyclic session or the continuous session is detected.

The MAC unit 4a′ sets a time in the timer 3 at which a beacon signal transmitted from the access point AP 1 can be received once in several times, until detection of the start of either the cyclic session or the continuous session.

Also, after either the cyclic session or the continuous session is detected, the MAC unit 4a′ sets the learned transmission cycle of the vicinity search packet as the time setting in the timer 3.

Note that the wireless terminal STA 1a performs a processing flow that is substantially the same as the processing flow of FIG. 4 except for learning the transmission cycle of the vicinity search packets until detection of the start of either the cyclic session or the continuous session.

Also, after either the cyclic session or the continuous session is detected, the wireless terminal STA 1a performs a processing flow that is substantially the same as the processing flow of FIG. 8. However, the reception timing of step S401 is the learned transmission cycle of the vicinity search packet.

Operations Flow in the Wireless Terminal

Learning Flow of the Wireless Terminal for the Transmission Cycle of Vicinity Search Packets

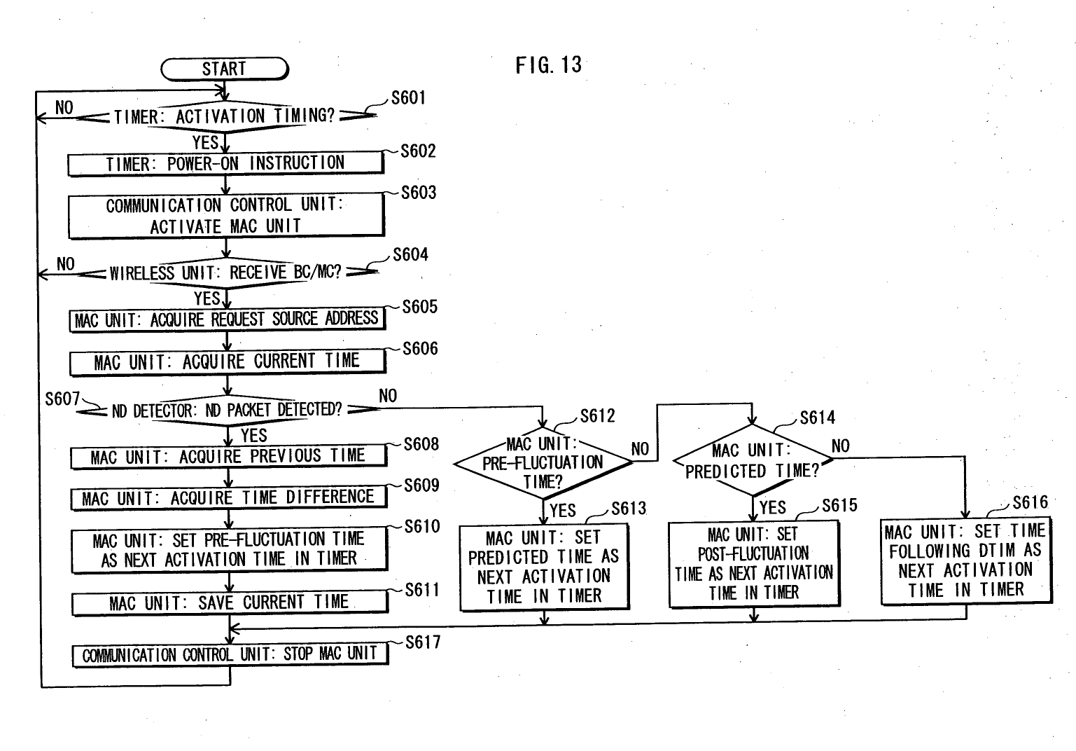

The following describes the processing whereby the wireless terminal learns the transmission cycle of a vicinity search packet with reference to FIG. 13. FIG. 13 is a flowchart showing a learning processing flow performed by the wireless terminal of FIG. 12 of a transmission cycle of a vicinity search packet. Note that FIG. 13 only shows steps necessary for learning the transmission cycle of the vicinity search packet.

The timer 3 determines whether an activation timing set by the MAC unit 4a′ has been reached (step S601). If the activation timing has been reached (S601:YES), the processing of step S602 is performed, and if the activation timing has not been reached (S601:NO), the processing of step S601 is performed.

The timer 3 sends a power-on instruction to the communication control unit 4′ (step S602). The communication control unit 4′ receives the power-on instruction and powers on the MAC unit 4a′ to activate the MAC unit 4a′. The MAC unit 4′ activates the wireless unit 6 (step S603).

The wireless unit 6 determines whether BC/MC frames have been received from the access point AP 1 (step S604). If BC/MC frames have not been received (S604:NO), the MAC unit 4′ stops the wireless unit 6, and the processing of step S601 is performed. If BC/MC frames have been received (S604:YES), the MAC unit 4′ stops the wireless unit 6, and the processing of step S605 is performed.

The MAC unit 4a′ analyzes the content of the BC/MC frames, acquires a request-source address (step S605), and acquires a current time (step S606).

The ND detector 8 determines whether a vicinity search packet such as an ND packet has been detected (step S607). If an ND packet has been detected (S607:YES), the processing of step S608 is performed.

The MAC unit 4a′ acquires a time stored in a memory that is not depicted at which a previous ND packet was detected (hereinafter called a previous time) from a memory that is not depicted (step S608), and furthermore acquires a time difference by subtracting the previous time acquired in step S608 from the current time acquired in step S606. Then, the MAC unit 4a′ sets a time obtained by adding a predetermined time that is shorter than the time difference to the current time as a pre-fluctuation time. The MAC unit 4a′ sets a time obtained by adding the time difference to the current time as a predicted time. The MAC unit 4a′ sets a time obtained by adding a predetermined time that is longer than the time difference to the current time as a post-fluctuation time (step S609).

The MAC unit 4a′ sets the pre-fluctuation time in the timer 3 as a next activation time (step S610). The MAC unit 4a′ saves the current time in a memory that is not depicted (step S611). The communication control unit 4′ stops the MAC unit 4a′ (step S617), and the processing of step S601 is performed.

In step S607, if ND packets are not detected (S607:NO), the MAC unit 4a′ determines whether the current time is the pre-fluctuation time (step S612). If the current time is the pre-fluctuation time (S612:YES), the MAC unit 4a′ sets the predicted time in the timer 3 as the next activation time (step S613). The communication control unit 4′ stops the MAC unit 4a′ (step S617), and the processing of step S601 is performed.

In step S612, if the current time is not the pre-fluctuation time (S612:NO), the MAC unit 4a′ determines whether the current time is the predicted time (step S614).

If the current time is the predicted time (S614:YES), the MAC unit 4a′ sets the post-fluctuation time in the timer 3 as the next activation time (step S615). The communication control unit 4 stops the MAC unit 4a (step S617) and the processing of step S601 is performed.

If the current time is not the predicted time (S614:NO), the MAC unit 4a′ sets, as the next activation time in the timer 3, a time at which a frame transmitted by broadcast or multicast can be received that is later than a beacon signal including a DTIM information element and is following the beacon signal (step S616). The communication control unit 4′ stops the MAC unit 4a′ (step S617), and the processing of step S601 is performed.

In this way, after the ND packet is detected, first, a next instance of ND packet detection is performed at three times (pre-fluctuation time, predicted time, and post-fluctuation time). If the next ND packet cannot be detected at the three times, the ND packet is detected by receiving a frame transmitted by broadcast or multicast following a beacon signal.

In this way, the difference between ND packet detection times is acquired a plurality of times. The MAC unit 4a′ learns, in accordance with the acquisition result, for example, the time difference having the greatest frequency as the ND packet transmission cycle. After the start of either the cyclic session or the continuous session has been detected, the MAC unit 4a′ sets the learned transmission cycle of the ND packet in an ND timer 3, and sends a power-on instruction to the timer 3 in accordance with the learned cycle.

Accordingly, after the start of either the cyclic session or the continuous session has been detected, the power-on instruction is sent to the communication control unit 4′ of the wireless terminal STA 1a in accordance with the learned transmission cycle of the ND packet upon generation of a transmission packet in the cyclic session or the continuous session whose start has been detected.

Supplementary Remarks

(1) In the above embodiment, a user interface may be provided in the wireless terminal STA 1a, and a function able to perform the following processing may be added to the wireless terminal STA 1a.

If the user performs a setting operation corresponding to a start of connecting a new wireless terminal, the original wireless terminal, which has detected the start of either a cyclic session or a continuous session and sent a power-on instruction to the communication control unit 4′ in accordance with the learned cycle of the ND packet, sends a power-on instruction with use of the user interface to the communication control unit 4′ in accordance with the transmission cycle of the beacon signal including the DTIM information element. Note that the power-on instruction may be sent at a timing at which the beacon signal including the DTIM information element can be received, or the power-on instruction may be sent at a timing at which a frame sent by broadcast or multicast following the beacon signal can be received and the beacon signal including the DTIM information element is not to be received.

Thereafter, if the user performs a setting operation corresponding to an end of acquiring an address of the new wireless terminal with use of the user interface, the original wireless terminal, which has detected the start of either a cyclic session or a continuous session and sent a power-on instruction to the communication control unit 4′ in accordance with the transmission cycle of the beacon signal including the DTIM information element, sends a power-on instruction to the communication control unit 4′ in accordance with the learned transmission cycle of the ND packet.

(2) In the above embodiment, the user interface may be provided in the wireless terminal STA 1a, and a function able to perform the following processing may be added to the wireless terminal STA 1a.

If the user performs a setting operation corresponding to a start of connecting a new wireless terminal, the original wireless terminal with use of the user interface, which has detected the start of either the cyclic session or the continuous session and sent a power-on instruction to the communication control unit 4′ in accordance with the learned cycle of the ND packet, sends a power-on instruction to the communication control unit 4′ in accordance with the transmission cycle of the beacon signal including the DTIM information element. Note that the power-on instruction may be sent at a timing at which the beacon signal including the DTIM information element can be received, or the power-on instruction may be sent at a timing at which a frame sent by broadcast or multicast following the beacon signal can be received and the beacon signal including the DTIM information element is not to be received.

If the wireless terminal STA 1a detects the ND packet transmitted by broadcast or multicast following the beacon signal including the DTIM information element, the wireless terminal, which has detected the start of either the cyclic session or the continuous session and has sent the power-on instruction to the communication control unit 4′ in accordance with the transmission cycle of the beacon signal including the DTIM information element, sends the power-on instruction to the communication control unit 4′ in accordance with the learned transmission cycle of the ND packet.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A wireless terminal, comprising:
a communication unit operable to perform wireless communication with a wireless base station;
a control unit operable to activate the communication unit upon receiving a power-on instruction;
a power-on instruction unit operable to transmit the power-on instruction to the control unit; and
a detection unit operable to detect a start of a repeating session in which transmission data is repeatedly generated, wherein
after the start of the repeating session has been detected by the detection unit, the power-on instruction unit transmits the power-on instruction upon an occurrence of an event pertaining to the transmission data in the repeating session.

2. The wireless terminal of claim 1, further comprising:
an accumulation unit operable to have accumulated therein transmission data of other sessions, wherein
after the start of the repeating session has been detected, the communication unit transmits the transmission data pertaining to the occurrence of the event in the repeating session and the transmission data that has accumulated in the accumulation unit.

3. The wireless terminal of claim 1, wherein
after the start of the repeating session has been detected, the communication unit (i) transmits the transmission data generated in the repeating session, and (ii) transmits a polling frame for acquiring, from the wireless base station, data addressed to the wireless terminal that has been accumulated in the wireless base station and receives the addressed data.

4. The wireless terminal of claim 1, wherein
the repeating session is a cyclic session in which the transmission data is generated at a predetermined cycle, and
if a plurality of the cyclic sessions have started, the power-on instruction unit transmits the power-on instruction upon the occurrence of the event that pertains to, from among the plurality of cyclic sessions, a cyclic session having a shortest cycle.

5. The wireless terminal of claim 1, wherein
after the start of the repeating session has been detected, the power-on instruction unit transmits the power-on instruction further upon an occurrence of an other event at a predetermined timing, the predetermined timing being when data transmitted by one of multicast and broadcast following a beacon signal from the wireless base station can be received and when the beacon signal from the wireless base station cannot be received.

6. The wireless terminal of claim 1, wherein
if a plurality of the repeating sessions have started, the power-on instruction unit transmits the power-on instruction upon the occurrence of the event that pertains to, from among the plurality of repeating sessions, at least one session of one of VoIP, MPEG-TS, and MPEG-PS.

7. The wireless terminal of claim 1, wherein
after the start of the repeating session has been detected, the power-on instruction unit transmits the power-on instruction further upon an occurrence of an other event of a predetermined control frame to be transmitted to the wireless base station.

8. The wireless terminal of claim 1, wherein
after the start of the repeating session has been detected, the power-on unit transmits a power-on instruction further upon an occurrence of an event of a timing at which a stream frame transmitted from the wireless base station can be received.

9. The wireless terminal of claim 1, further comprising:
a vicinity search frame detection unit operable to detect a vicinity search frame including an address of an other wireless terminal that has been transmitted via one of broadcast and multicast from the wireless base station;
a cycle detection unit operable to, based on a result of the detection performed by the vicinity search frame detection unit, detect a cycle at which the vicinity search frame is transmitted, wherein
after the start of the repeating section has been detected, the power-on instruction unit transmits a power-on instruction further upon the occurrence of an event of the cycle at which the vicinity search frame detected by the vicinity search frame detection unit is transmitted.

10. The wireless terminal of claim 9, further comprising:
a user setting unit operable to receive a setting operation from a user, wherein
after the start of the repeating session has been detected, during a period that begins when the user setting unit receives a predetermined first setting operation and ends when the user setting unit receives a second predetermined setting operation, the power-on instruction unit transmits the power-on instruction upon the occurrence of an event of a cycle of a beacon signal that accompanies a transmission of a frame via one of broadcast and multicast, instead of upon the occurrence of the event of the cycle at which the vicinity search frame detected by the vicinity search frame detection unit is transmitted.

11. The wireless terminal of claim 9, further comprising:
a user setting unit operable to receive a setting operation from a user, wherein
after the start of the repeating session has been detected, during a period that begins when the user setting unit receives a predetermined setting operation and ends when the vicinity search frame detection unit detects a vicinity search frame, the power-on instruction unit transmits the power-on instruction upon the occurrence of an event of a cycle of a beacon signal that accompanies a transmission of a frame via one of broadcast and multicast, instead of upon the occurrence of the event of the cycle at which the vicinity search frame detected by the vicinity search frame detection unit is transmitted.

12. A control method for a wireless terminal that includes a communication unit that performs wireless communication with a wireless base station, a control unit that activates the communication unit upon receiving a power-on instruction, and a power-on instruction unit that transmits the power-on instruction to the control unit, the control method comprising:
a detection step of detecting a start of a repeating session in which transmission data is repeatedly generated; and
a power-on instruction step of transmitting the power-on instruction upon an occurrence of an event pertaining to the transmission data in the repeating session, after the start of the repeating session has been detected in the detection step.
